(19) United States
(12) Patent Application Publication
(10) Pub. No.: US 2014/0363804 A1
(43) Pub. Date: Dec. 11, 2014

(54) TOOL FOR TRACKING THE ACCOMPLISHMENT OF DAILY AND WEEKLY GOALS AND TASKS

(71) Applicant: Chris A. Vercelli, Sarasota, FL (US)

(72) Inventor: Chris A. Vercelli, Sarasota, FL (US)

(21) Appl. No.: 14/300,080

(22) Filed: Jun. 9, 2014

Related U.S. Application Data
(60) Provisional application No. 61/832,937, filed on Jun. 9, 2013.

(51) Int. Cl. G09B 19/00; B43L 1/00

(52) U.S. Cl. CPC G09B 19/00; B43L 1/00
USPC 434/408

(57) ABSTRACT

A daily scoreboard kit has a daily scoreboard, dry erase markers, an eraser, mounting accessories, and the like. The daily scoreboard can include a region for listing short term/daily goals, and regions for each day of the week, where the user can signify if that particular daily goal was accomplished for that day of the week. The scoreboard includes a region to indicate the particular week in question and a place to tally their score for the week. By having a visual reminder, the present invention will help the user achieve their goals. In doing this, the user can conquer laziness and procrastination and make progress in goals each and every day. Once momentum is built over the course of several weeks, one would be much more likely to continue towards their health, work, financial, spiritual and relationship goals that are most important to them.

### CROSS REFERENCE TO RELATED APPLICATIONS

This application claims the benefit of U.S. provisional patent application No. 61/832,937, filed Jun. 9, 2014, the contents of which are herein incorporated by reference.

### BACKGROUND OF THE INVENTION

The present invention relates to organization and tracking tools and, more particularly, to a board that can be used to track the accomplishment of daily and weekly goals and tasks.

People have a hard time conquering laziness, complacency and procrastination. People need a way to hold themselves accountable to the daily things that need to be done to achieve their bigger, longer term goals. Many people live very mediocre lives and need to take daily and weekly steps to work towards their goals and dreams in order to live the life they truly want and to be less dependent on others.

Email, texts, calls, online surfing and social media often monopolize a user's primary attention during computer and mobile device time. Expecting that the average person will also use their phone or computer successfully to track and monitor the sometimes challenging daily task goals that need to be accomplished may not be a good assumption. Moreover, electronic tools have to be opened and checked on a regular basis to even be reminded of what is listed on them. This takes time and can be easily neglected if the person forgets or just doesn't want to look at it, resulting in an out of sight, out of mind issue.

As can be seen, there is a need for simple, easy to use, visual reminder of small, daily goals that need to be accomplished in order to move toward bigger, longer term goals.

### SUMMARY OF THE INVENTION

In one aspect of the present invention, a daily scorecard comprises first region having a plurality of rows for receiving goals of a user; a second region having a plurality of columns, each of the plurality of columns positioned horizontally from each of the plurality of rows of the first region, each of the plurality of columns operable to receive a mark designating completion or non-completion of the goal within a given period of time, where each of the plurality of columns corresponds to the given period of time; and a third region for tallying the marks designating completion of the goal and the marks designating non-completion of the goal.

In another aspect of the present invention, a daily scorecard kit comprises one or more dry-erase markers; one or more dry-erase erasers; and a daily scorecard, the daily scorecard includes a first region having a plurality of rows for receiving goals of a user; a second region having a plurality of columns, each of the plurality of columns positioned horizontally from each of the plurality of rows of the first region, each of the plurality of columns operable to receive a mark designating completion or non-completion of the goal within a given period of time, where each of the plurality of columns corresponds to the given period of time; and a third region for tallying the marks designating completion of the goal and the marks designating non-completion of the goal.

In a further aspect of the present invention, a method for motivating a user to complete goals comprises displaying a daily scorecard, the daily scorecard includes a first region having a plurality of rows; a second region having a plurality of columns, each of the plurality of columns positioned horizontally from each of the plurality of rows of the first region, each of the plurality of columns corresponds to a given period of time; and a third region for tallying marks designating completion of the goal and marks designating non-completion of the goal; listing the goals of the user in the first region; marking the second region for each period of time to designation the completion or non-completion of the goal; and tallying a score in the third region, where the score shows at least one of a sum of the marks designating completion of the goal and a sum of the marks designation non-completion of the goal.

These and other features, aspects and advantages of the present invention will become better understood with reference to the following drawings, description and claims.

### BRIEF DESCRIPTION OF THE DRAWINGS

FIG. 1 is a front view of a daily scoreboard kit according to an exemplary embodiment of the present invention;

FIG. 2 is a front view of the daily scoreboard of the daily scoreboard kit of FIG. 1; and

FIG. 3 is a front view of the daily scoreboard, in use, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a daily scoreboard kit having a daily scoreboard, dry erase markers, an eraser, mounting accessories, and the like. The daily scoreboard can include a region for listing short term (daily) goals, and regions for each day of the week, where the user can signify if that particular daily goal was accomplished for that day of the week. The scoreboard includes a region to indicate the particular week in question and a place to tally their score for the week.

By having a visual reminder, the present invention will help the user achieve their goals. In doing this, the user can conquer laziness and procrastination and make progress in goals each and every day. Once momentum is built over the course of several weeks, one would be much more likely to continue towards their health, work, financial, spiritual and relationship goals that are most important to them. Also, having a visual reminder of how well one is doing in achieving their small goals gives the user a sense of accomplishment and satisfaction, even before the bigger, long term goals are reached.

Unlike electronic tools, which must be powered on, opened, and viewed, the daily scorecard of the present invention can be placed in a prominent location where it can be easily viewed during everyday activities of the user, reminding them of the goals that need to be achieved for the day. By placing it in such a prominent location, other people in the household may also see the daily scorecard and help motivate the user to achieve their daily goals each and every day.

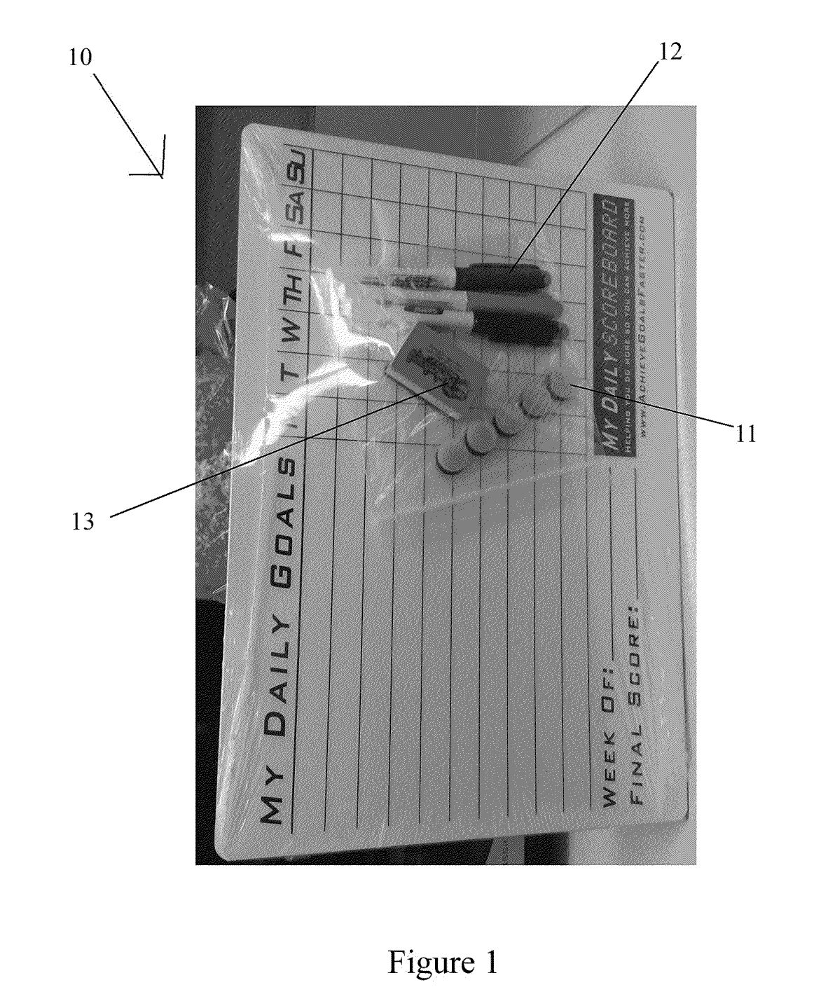

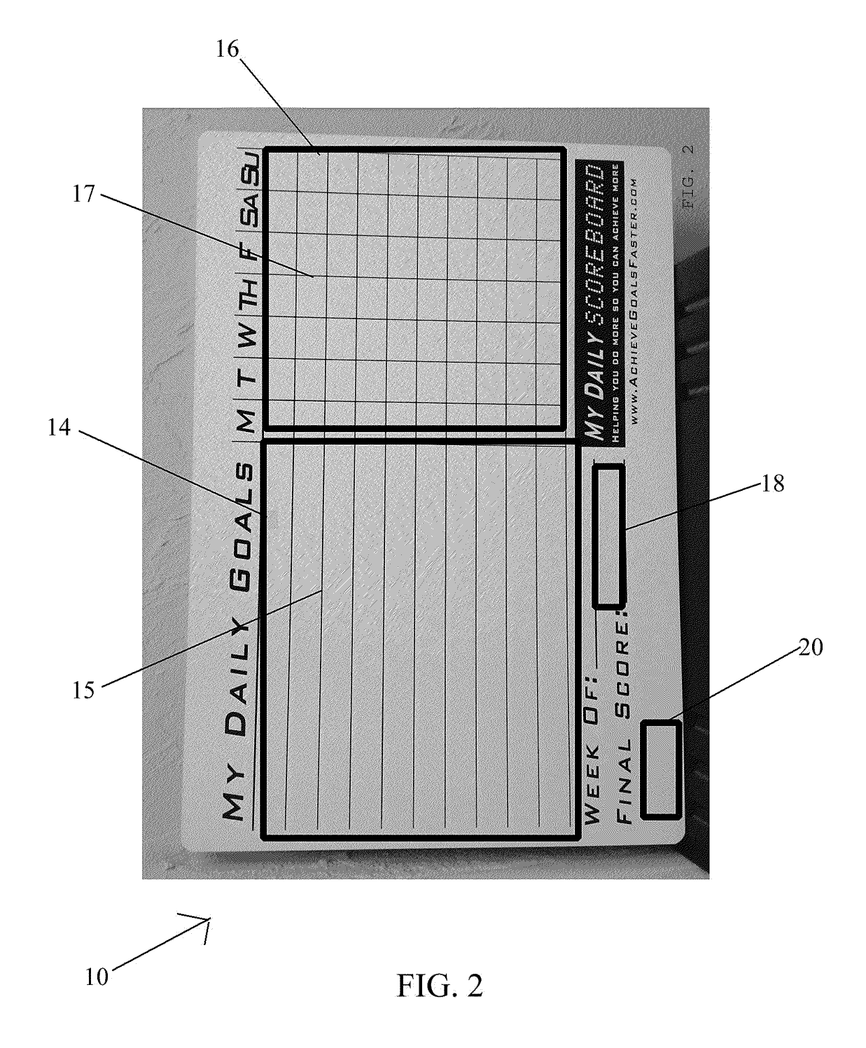

Referring now to FIGS. 1 through 3, in some embodiments of the present invention, a daily scorecard 10 can be provided as a dry erase board where dry erase markers 12 can be used to write in the daily goals in a goals region 14 and whether they have been accomplished each day in a goal tracker region 16. The daily scorecard 10 can also include mounts 11 for attaching the daily scorecard 10 to a surface. A dry-erase eraser 13 can be provided for changing goals entered into the goals region 14 or for clearing the goal tracker region 16 after each week is passed.

At the end of each week, the user can tally their “score” to track their overall progress. A score keeping region 18 is provided to tally one's score for the week. In some embodiments, an additional score region 20 can be dedicated to place the prior week's score so that overall week-to-week improvement may be tracked. The goal region 14 can include a plurality of horizontal lines 15 that extend through the goal tracker region 16. The goal tracker region 16 can include a plurality of vertical lines 17 that form a grid with the horizontal lines 15. The horizontal lines 15 and the vertical lines 17 can be disposed on the daily scorecard 10 in a permanent manner, where the user can keep track of their score with a dry-erase marker that can be erased with the eraser 13 without erasing the horizontal lines 15 and vertical lines 17.

While the figures show the goal tracker region 16 as covering one week, this may be set up to cover only weekdays, weekends, more than one week, or the like. Moreover, while the figures show a single daily scorecard 10, in some embodiments, multiple ones of the daily scorecard 10 may be formed integrally. For example, each member of an entire family may use their own daily scorecard 10, and each of these scorecards may be joined together to form a single, easy to access, scorecard.

In other embodiments, the daily scorecard can be an electronic touchpad, where the user can write goals and accomplishments with a stylus and the touchpad would show this writing on the board. The electronic version of the board could, via a wireless signal, synchronize with a software application that shows the daily scorecard on the user's computer and allows the user to mark off accomplishments remotely. In some embodiments, the electronic version could synchronize with a travel version of the board, providing a way to track accomplishments not only at home but also when one is away from work. Of course, the dry erase board design could include removable mounts, where the user could simply take the board with them during times away from home.

To use the daily scoreboard, the user would first want to identify large, long term goals. Next, the user can identify the small, daily goals that need to be achieved to move in the direction of reaching the long term goals. These daily goals can be written on the daily scorecard and the user would mark the days of the week where the goal was achieved in one manner, and the days of the week where the goal was not achieved in a different manner. At the end of the week, the user can, at a glance, see their progress in achieving their goals.

While the above describes using the daily scoreboard of the present invention as a motivation tool, the device can be used for other purposes as well, such as for keeping children accountable for daily chores, for keeping employees accountable for daily tasks, as a reminder for medications or other such items, or any other task that needs to be accomplished each day.

It should be understood, of course, that the foregoing relates to exemplary embodiments of the invention and that modifications may be made without departing from the spirit and scope of the invention as set forth in the following claims.

What is claimed is:

1. A daily scorecard comprising:
a first region having a plurality of rows for receiving goals of a user, the rows delineated with permanent lines;
a second region having a plurality of columns, the plurality of columns delineated with permanent lines, each of the plurality of columns positioned horizontally from each of the plurality of rows of the first region, each of the plurality of columns operable to receive a mark designating completion or non-completion of the goal within a given period of time, where each of the plurality of columns corresponds to the given period of time; and
a third region for tallying the marks designating completion of the goal and the marks designating non-completion of the goal.

2. The daily scorecard of claim 1, wherein a front surface of the daily scorecard is formed from a material upon which a dry-erase marker can be written and erased therefrom.

3. The daily scorecard of claim 1, wherein lines designating the plurality of rows of the first region extend through the second region to form a grid with the plurality of columns.

4. A daily scorecard kit comprising:
one or more dry-erase markers;
one or more dry-erase erasers; and
a daily scorecard, the daily scorecard including:
a first region having a plurality of rows for receiving goals of a user, the rows delineated with permanent lines;
a second region having a plurality of columns, the plurality of columns delineated with permanent lines, each of the plurality of columns positioned horizontally from each of the plurality of rows of the first region, each of the plurality of columns operable to receive a mark designating completion or non-completion of the goal within a given period of time, where each of the plurality of columns corresponds to the given period of time; and
a third region for tallying the marks designating completion of the goal and the marks designating non-completion of the goal.

5. The daily scorecard kit of claim 4, wherein a front surface of the daily scorecard is formed from a material upon which a dry-erase marker can be written and erased therefrom.

6. The daily scorecard kit of claim 4, wherein lines designating the plurality of rows of the first region extend through the second region to form a grid with the plurality of columns.

7. The daily scorecard kit of claim 4, further comprising one or more mounts for mounting the daily scorecard onto a surface.

8. A method for motivating a user to complete goals comprising:
displaying a daily scorecard, the daily scorecard including:
a first region having a plurality of rows for receiving goals of a user, the rows delineated with permanent lines;
a second region having a plurality of columns, the plurality of columns delineated with permanent lines, each of the plurality of columns positioned horizontally from each of the plurality of rows of the first region, each of the plurality of columns corresponds to a given period of time; and
a third region for tallying marks designating completion of the goal and marks designating non-completion of the goal;
listing the goals of the user in the first region;
marking the second region for each period of time to designation the completion or non-completion of the goal; and
tallying a score in the third region, where the score shows at least one of a sum of the marks designating completion of the goal and a sum of the marks designation non-completion of the goal.

9. The method of claim 8, further comprising displaying the daily scorecard in an area visible by others in addition to the user.

10. The method of claim 8, further comprising erasing the second region and the third region after a plurality of the given periods of time and repeating the method.

11. The method of claim 10, further comprising writing the tallied score in a fourth region of the daily scorecard before erasing the second region and the third region.
